(19) United States
(12) Patent Application Publication
(10) Pub. No.: US 2008/0199154 A1
(43) Pub. Date: Aug. 21, 2008

(54) Apparatus and method with frame-by-frame display control

(76) Inventors: Yuichi Kanai, Ichinomiya-Shi (JP); Yoshinori Kawasaki, Anpachi-Gun (JP)

Correspondence Address: MCDERMOTT WILL & EMERY LLP, 600 13TH STREET, N.W., WASHINGTON, DC, 20005-3096, US

(21) Appl. No.: 12/010,400

(22) Filed: Jan. 24, 2008

(30) Foreign Application Priority Data
Jan. 24, 2007 (JP) 2007-013195
Jan. 31, 2007 (JP) 2007-022522

(51) Int. Cl. H04N 7/26

(52) U.S. Cl. 386/124

(57) ABSTRACT

In recording the positional information of a video frame in a program stored in a removable hard disk unit in which MPEG transport data stream is recorded, there are recorded information indicating the position in the removable hard disk unit at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame.

### CROSS-REFERENCE TO RELATED APPLICATIONS

This application is based upon and claims the benefit of priority from the prior Japanese Patent Applications No. 2007-013195, filed Jan. 24, 2007, and Japanese Patent Application No. 2007-022522, filed Jan. 31, 2007, the entire contents of which are incorporated herein by reference.

### BACKGROUND OF THE INVENTION

1. Field of the Invention

The present invention relates to data recording technologies and, more particularly, to recording apparatuses and methods, playback apparatuses and methods, and data structures in which display is controlled frame by frame.

2. Description of the Related Art

In recording and reproducing digital television, it is a general practice to deal with an MPEG-TS stream. An MPEG-TS includes a program association table (PAT) which lists the PIDs of program map tables (PMT) corresponding to program numbers, and PMT packets which list the PIDs of video data, audio data, accessory data, and program clock references (PCR) included in the associated program. Video and audio packets can be isolated and processed for decoding, by analyzing the PAT and the PMT packets. Meanwhile, apparatuses capable of frame-by-frame editing an MPEG PS stream are known.

As generally known, the stream structure of analog broadcast, encoded in an apparatus and recorded on a DVD or a hard disk as an MPEG PS stream, is readily known at the time of encoding so that the frame-by-frame control by referring to presentation time stamp (PTS) is enabled in starting playback, ending playback, indexing, and editing the stream. Meanwhile, in the case of recording MPEG-TS digital broadcast stream, management by using PTS requires extracting PTSs by analyzing the received stream, thereby imposing a load on a recording device. For this reason, a scheme called streaming is generally practiced in which a stream is not analyzed and management is based on arrival time stamps. When designating a position of starting or ending the playback of a MPEG-TS, failure to start or end at a desired position is caused in actual playback because it is impossible to designate a position on the frame by frame basis.

In this background, a general purpose of the present invention is to allow designating a frame in editing or displaying a stored MPEG-TS stream.

One embodiment of the present invention relates to a recording apparatus. The recording apparatus comprises: an acknowledging unit which acknowledges a request for recording positional information of a video frame in a program stored in a recording medium in which MPEG transport stream data is recorded; and a positional information recording unit which records, as positional information of the video frame, information on the position in the recording medium at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame.

Another embodiment of the present invention relates to a recording method. The recording method comprises: acknowledging a request for recording positional information of a video frame in a program stored in a recording medium in which MPEG transport stream data is recorded; and recording, as positional information of the video frame, information on the position in the recording medium at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame.

Another embodiment of the present invention relates to a playback apparatus. The playback apparatus comprises: a decoder unit which extracts and decodes a transport packet, storing a video elementary stream of a program, from MPEG transport stream data; a positional information acquiring unit which acquires, as positional information of a video frame in a program stored in a recording medium in which the MPEG transport stream data is recorded, information on the position in the recording medium at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame; and an identifying unit which identifies the video frame by using the positional information, wherein the identifying unit uses the information on the recorded position acquired by the positional information acquiring unit to read data, including the GOP to which the video frame belongs, from the recording medium, and supplies the data to the decoding unit, the decoder uses the packet identifier acquired by the positional information acquiring unit to extract and decode the transport packet having the packet identifier from among the data supplied by the identifying unit, and the identifying unit uses the offset frame number or the offset time stamp information acquired by the positional information acquiring unit to identify the video frame from among the video frames decoded by the decoding unit.

Still another embodiment of the present invention relates to a playback method. The playback method comprises: acquiring, as positional information of a video frame in a program stored in a recording medium in which the MPEG transport stream data is recorded, information on the position in the recording medium at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame; and identifying the head of the GOP to which the video frame belongs, by using the information on the recorded position and the packet identifier; and identifying the video frame in the GOP by using the offset frame number or the offset time stamp information.

Optional combinations of the aforementioned constituting elements, and implementations of the invention in the form of methods, apparatuses, systems, and the like may also be practiced as additional modes of the present invention.

### BRIEF DESCRIPTION OF THE DRAWINGS

FIG. 1 shows the structure of a recording and playback apparatus according to an embodiment.

FIG. 2 shows the format for storage of video and audio data.

FIG. 3 shows an example of an MPEG transport stream.

FIG. 4 shows the structure of directories and files recorded in a removable HDD unit.

FIG. 5 shows the data structure of a PGRG manager.

FIG. 6 shows the data structure of a PGRGI.

FIG. 7 shows the data structure of an OPGR manager.

FIG. 8 shows the data structure of an OPGRI.

FIG. 9 shows the data structure of a UPGR manager.

FIG. 10 shows the data structure of a related-art UPGRI.

FIG. 11 shows how a video and audio data file is referred to by using a related-art UPGRI.

FIG. 12 shows how a reference start position and a playback start position in a transport stream are related according to the related art.

FIG. 13 shows how a reference start position and a playback start position in a GOP are related according to the related art.

FIG. 14 shows the data structure of a UPGRI and how a video and audio data file is referred to according to the embodiment.

FIG. 15 shows how a reference start position and a playback start position in a transport stream are related according to the embodiment.

FIG. 16 shows the structure of a sequence of frames in a GOP in the MPEG video layer in the presentation order.

FIG. 17 shows the data structure of a UPGRI and how a video and audio data file is referred to according to the embodiment.

FIG. 18 shows the structure of a frame position managing unit according to the embodiment.

FIG. 19 is a flowchart showing the procedure for playback according to the embodiment.

### DETAILED DESCRIPTION OF THE INVENTION

The invention will now be described by reference to the preferred embodiments. This does not intend to limit the scope of the present invention, but to exemplify the invention.

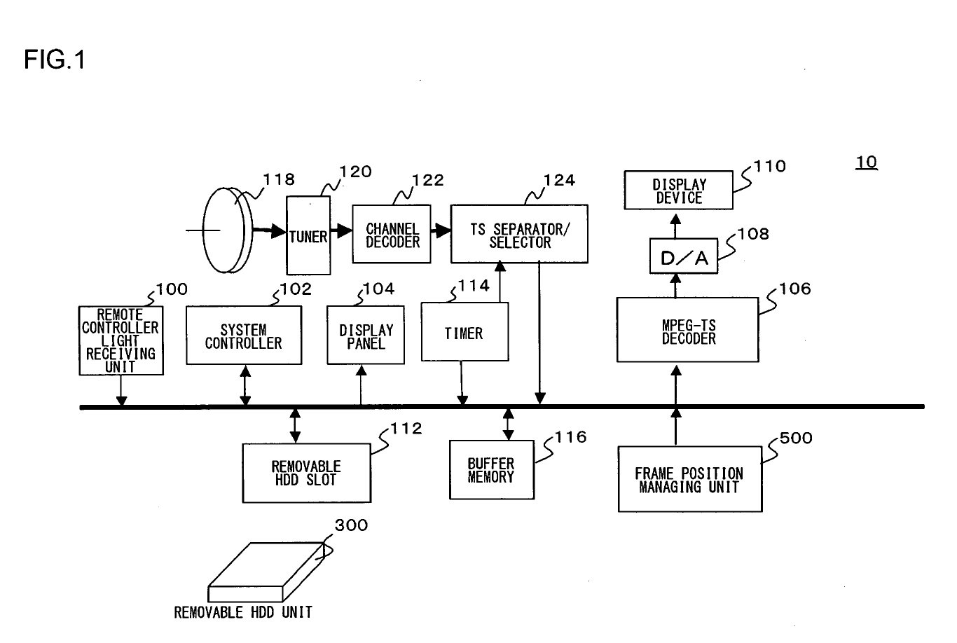

FIG. 1 shows an example showing how the invention is used for digital television recording and playback applications. A receiver 10 which uses a removable hard disk drive (HDD) as a recording medium comprises a light receiving unit 100 for receiving commands from a remote controller, a system controller 102, a display panel 104, an MPEG-TS decoder 106, a D/A converter 108, a display device 110, a removable HDD slot 112, a timer 114, a buffer memory 116, an antenna 118, a tuner 120, a channel decoder 122, a TS separator/selector 124, and a frame position managing unit 500. The removable HDD unit 300 is a recording medium used in the receiver 10.

The basic operation for storage and playback of digital broadcast will be described by referring to FIG. 1. The antenna 118 receives digitally modulated signals. The tuner 120 selects a channel selected by a user in accordance with a direction from the system controller 102, and extracts a signal of the selected channel from the signals received by the antenna 118. The channel decoder 122 decodes the signal extracted by the tuner 120 to reproduce the format of video and audio data encoded in MPEG2, and outputs the reproduced data to the TS separator/selector 124. When the video and audio data is not stored in the removable HDD unit 300 and played back on the display device 110, the system controller 102 allows the TS separator/selector 124 to output the video and audio data to the MPEG-TS decoder 106. The video and audio data decoded by the MPEG-TS decoder 106 is converted by the D/A converter 108 into an analog signal and output to the display device 110. When the video and audio data is stored in the removable HDD unit 300, the system controller 102 allows the TS separator/selector 124 to output the data to the removable HDD unit 300 via the removable HDD slot 112, while maintaining information on packet intervals with the use of the timer 114, so that the video and audio data is stored in the removable HDD unit 300. In this process, the system controller 102 functions as a recorder which obtains data for a MPEG transport stream and records the data in the removable HDD unit 300.

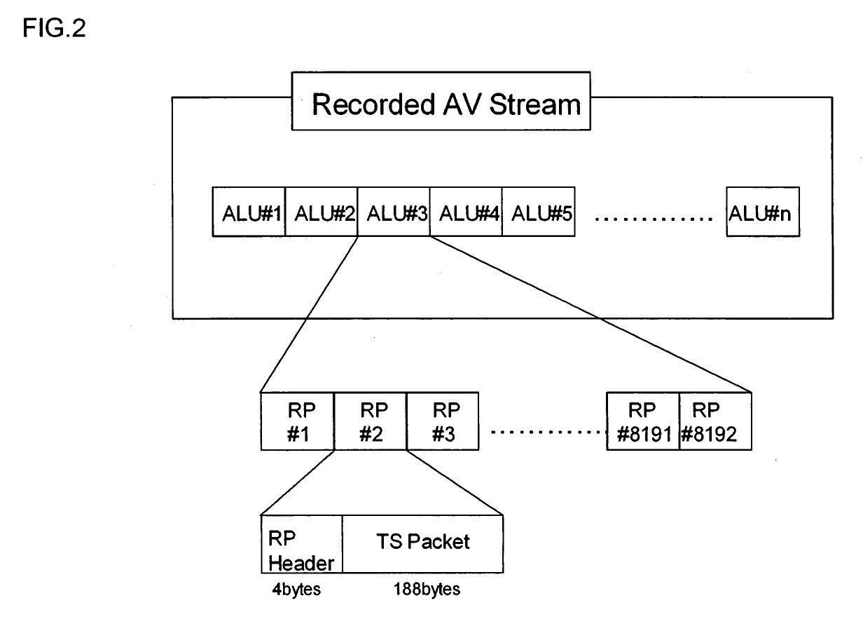

FIG. 2 shows a format for storing the video and audio data. A block comprising a 188-byte MPEG-TS packet and a 4-byte RP header will be referred to as a recording packet (RP). The 4-byte RP header represents time stamp information produced by a counter at 27 MHz in order to maintain information on packet intervals in the process of producing a partial transport stream by extracting one program from a transport stream in which a plurality of programs are multiplexed for recording. The RP header is generated by the timer 114. An allocation unit (ALU) includes 8192 RPs and represents a contiguous area in the recording medium allocatable. Thus, by recording a packet of a predetermined volume in a contiguous area of the removable HDD unit 300, overhead incurred due to a seek operation is reduced and realtime recording or playback is enabled. The size of an ALU may be defined in accordance with the property of a recording medium (seek time, latency time, and transfer rate) so as to ensure realtime recording or playback.

In order to play back a broadcast program recorded in the removable HDD unit 300, the system controller 102 reads from the removable HDD unit 300 video and audio data corresponding to the title to be played back and causes the TS packet to be sent to the MPEG-TS decoder 106 in a timing schedule defined by the information in the RP header. In this way, the video and audio data is output to the display device 110 via the MPEG-TS decoder 106 and the D/A converter 108 much like when a broadcast signal is received. In this process, the system controller 102 functions as a playback unit for reading program data from the removable HDD unit 300 for playback.

A brief explanation will be given of the process performed in the MPEG-TS decoder 106. In playing back a partial TS stored in the removable HDD unit 300, selection for playback of desired packets in the video and audio stream is enabled by analyzing a PAT and PMT packets in a TS stream. More specifically, the PAT (PID=0) is referred to so as to know the PID of the PMT corresponding to a desired program. By referring to the PIDs listed in the PMT (PID=a), video packets (PID=b) and audio packets (PID=c) of the desired program can be identified. This allows video packets and audio packets to be isolated from the MPEG-TS stream. Video and audio obtained by decoding the isolated stream are output to the display device 110 via the D/A converter 108.

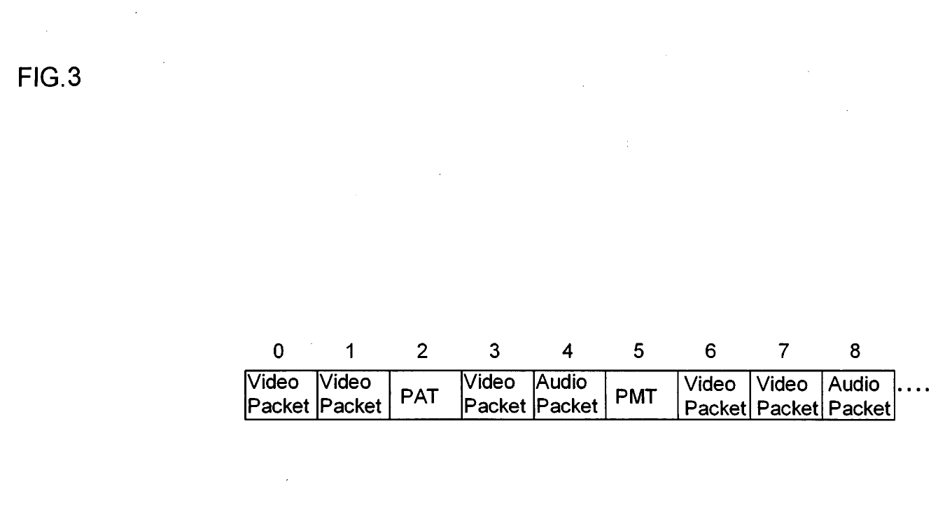

The stream of FIG. 3 will be assumed as an example of MPEG-TS stream. A video packet (0), a video packet (1), a PAT (2), a video packet (3), an audio packet (4), a PMT (5), a video packet (6), a video packet (7), and an audio packet (8) arrive in the stated order. To decode video and audio, the information of the PAT is necessary so that the system waits for a packet with PID=0. Thus, the video packet (0) and the video packet (1) at the head are not processed and discarded. The PAT (2) is then referred to so as to obtain the PID (PID=a) of the PMT written in the PAT (2). It is learned thus that the PID of the necessary PMT is “a⇄ (PID=a). Since the PID of the video packet (3) and the audio packet (4) is not “a”, these packets are not processed and discarded. The PMT (5) with the PID of “a” arrives subsequently. By analyzing the PMT, the PID of the video packet (PID=b) and the PID of the audio packet (PID=c) are obtained. At this stage, the PIDs of the video packet and the audio packet storing data for the desired program are known. Thus, it is possible to play back video and audio by decoding the video packet (6), the video packet (7), and the audio packet (8), which arrive subsequently.

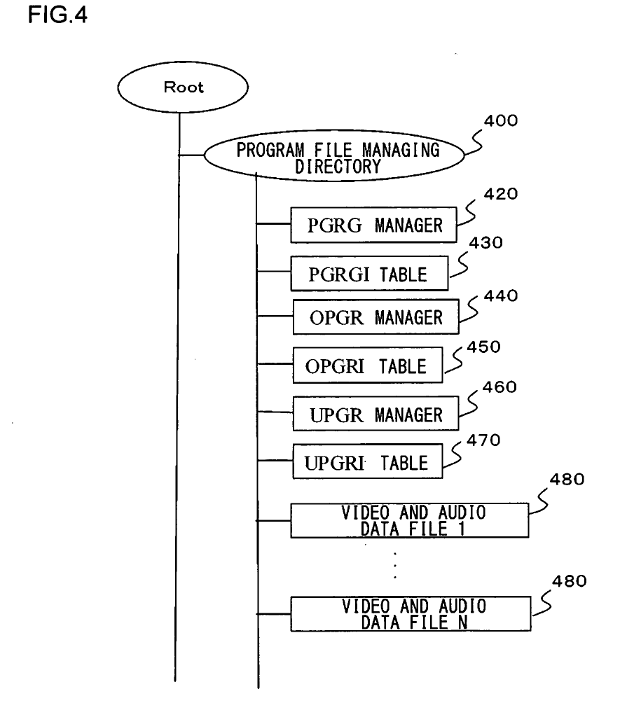

FIG. 4 shows the structure of directories and files recorded in the removable HDD unit 300. A program file management directory 400 is located beneath the root directory. In the system of the exemplary embodiments, operations are performed in this directory. A program file actually recorded is stored as a video and audio data file 480. FIG. 2 shows the format of the file. Files managing the data include a PGRG manager 420, a PGRGI table 430, an OPGR manager 440, an OPGRI table 450, a UPGR manager 460, and a UPGRI table 470.

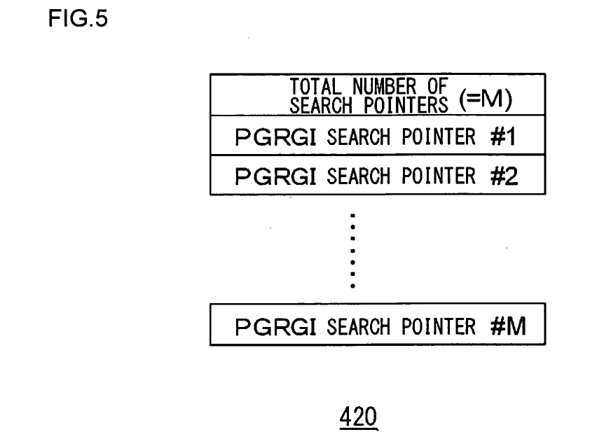

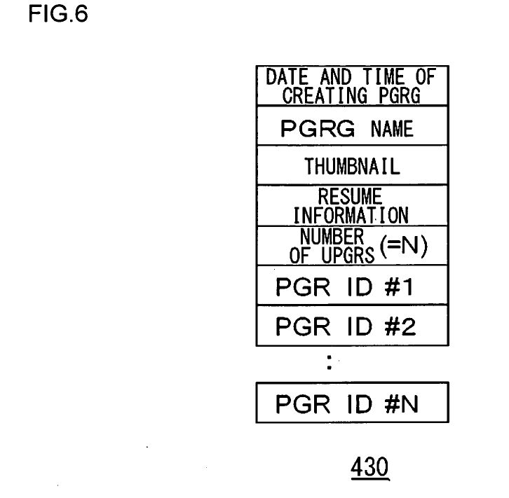

FIGS. 5 and 6 shows the structure of the PGRG manager and the PGRGI, respectively. A PGRGI represents an edited title recorded. When a program stored is edited virtually, a PGRGI is created. The PGRGI table 430 comprises a list of PGRGIs. As shown in FIG. 6, a PGRGI maintains the date of creating the PGRG, name, thumbnail, resume information, the number of UPGRs included, and the ID of the UPGRs. The PGRG manager 420 is a file for managing the PGRGIs and is formatted such that a desired PGRGI can be designated by listing the byte positions relative to the head of the PGRGI table. As shown in FIG. 5, the PGRG manager maintains the total number of PGRGIs and the search pointers of the respective PGRGIs. Thus, the user can select an edited title via the PGRG manager.

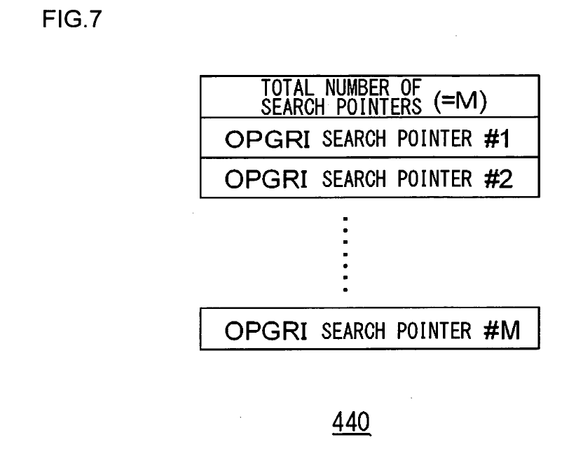

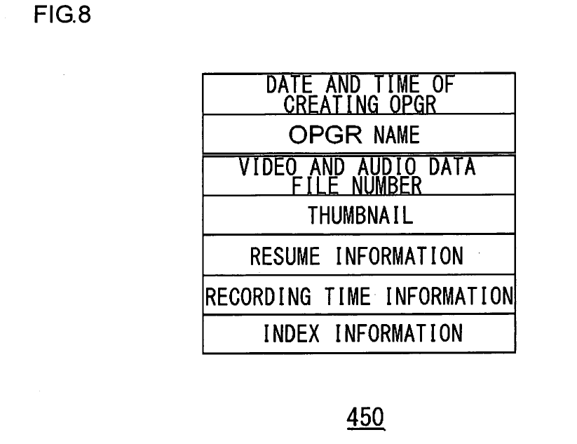

FIGS. 7 and 8 show the structure of the OPGR manager and the OPGRI. An OPGRI represents information of a program recorded. When a program is recorded as the video and audio data file 480, an OPGRI is created concurrently. The OPGRI table 450 comprises a list of OPGRIs. As shown in FIG. 8, an OPGRI maintains the date of creating the OPGR, name, the video and audio file number, thumbnail, resume information, recording time information, and index information. The OPGR manager 440 is a file for managing the OPGRIs and is formatted such that a desired OPGRI can be designated by listing the byte positions relative to the head of the OPGRI table 450. As shown in FIG. 7, the OPGR manager 440 maintains the total number of OPGRIs and the search pointers of the respective OPGRIs. Thus, the user can select a recorded program via the OPGR manager 440.

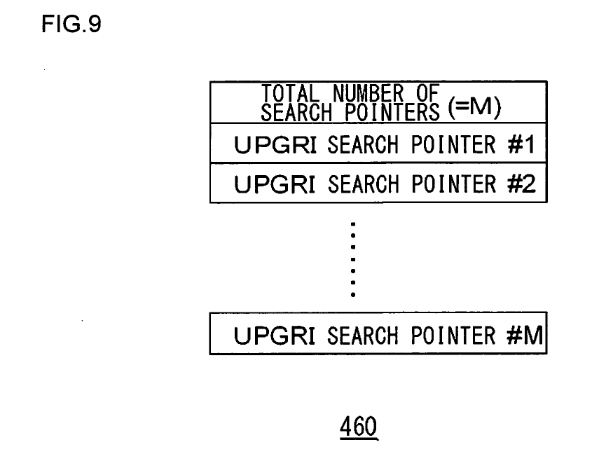

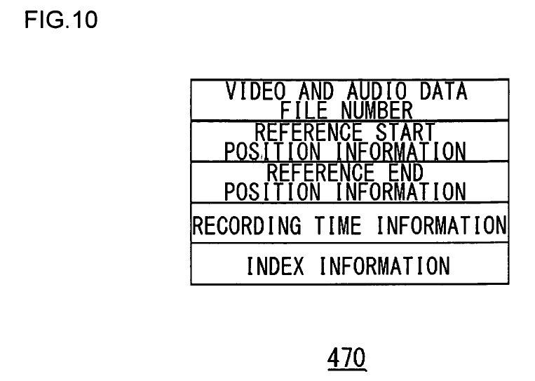

FIGS. 9 and 10 show the structure of the UPGR manager and the UPGRI. A UPGRI is created when a part of a recorded program file is designated and is created when performing virtual editing. A PGRG is a list of UPGRIs. In virtual editing, a stream itself is not edited, but a stream is displayed as if it is edited, by externally referring to the stream. The UPGRI table 470 comprises a list of UPGRIs. As shown in FIG. 10, a UPGRI maintains the video and audio data file number, reference start position information, reference end position information, recording time information, and index information. Meanwhile, the UPGR manager 460 is a file for managing the UPGRIs and is formatted such that a desired UPGRI can be designated by listing the byte positions relative to the head of the UPGRI table 470. As shown in FIG. 9, the UPGR manager 460 maintains the total number of UPGRIs and the search pointers of the respective UPGRIs.

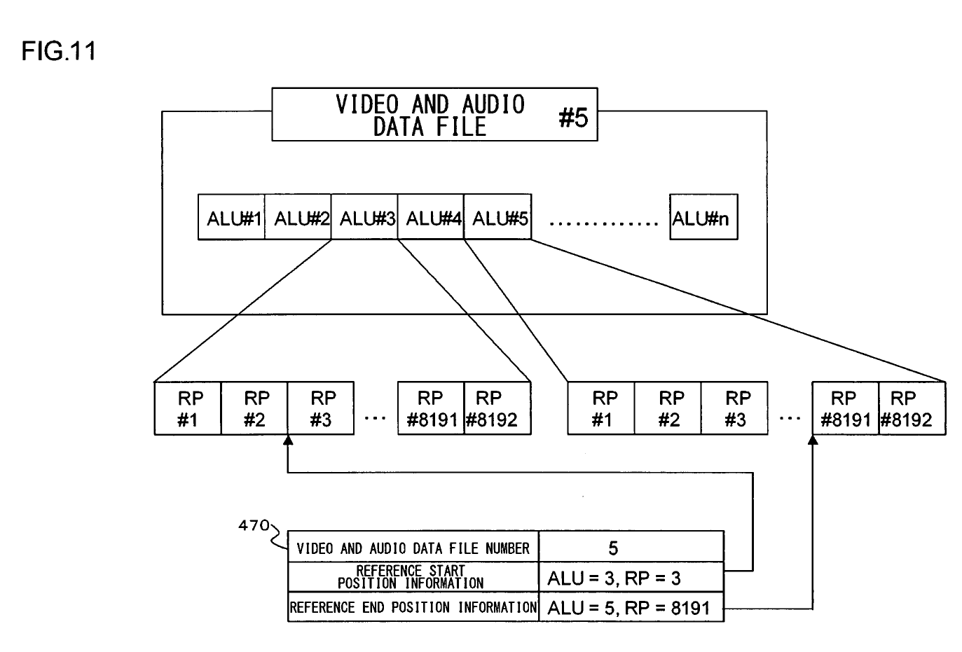

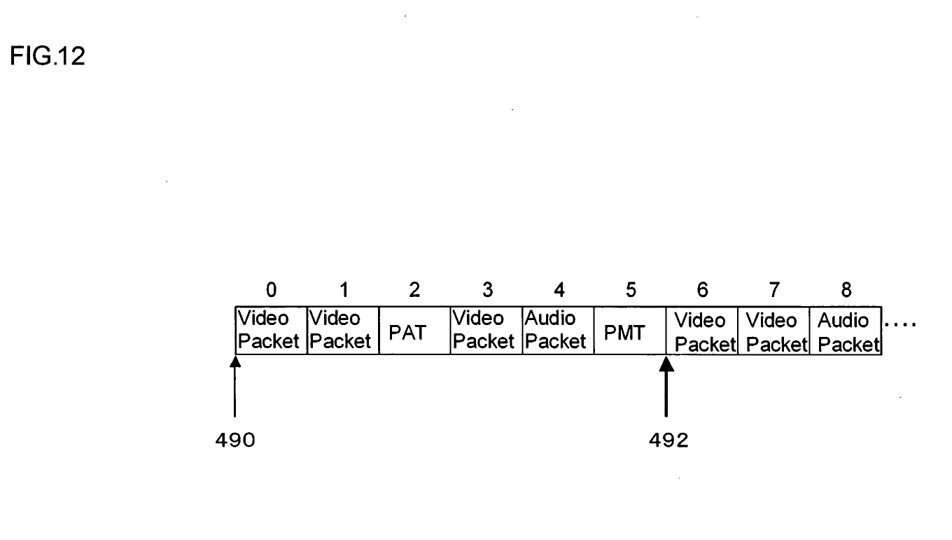

FIG. 11 shows how a video and audio data file is referred to by using a UPGRI. The file with the video data file number of #5 is selected. The position identified by the ALU number of #3 and the RP number of #3 is shown as a reference start position. The position identified by the ALU number of #5 and the RP number of #8191 is shown as a reference end position. As mentioned before, if playback is to be started at the reference start position, video packets and audio packets are discarded until the PAT and the PMT are analyzed. Thus, as shown in FIG. 12, even if the position of the video packet (0) at the head with the RP number of #3 is designated as a reference start position 490, actual decoding is started at the position 492 following the PMT packet (5).

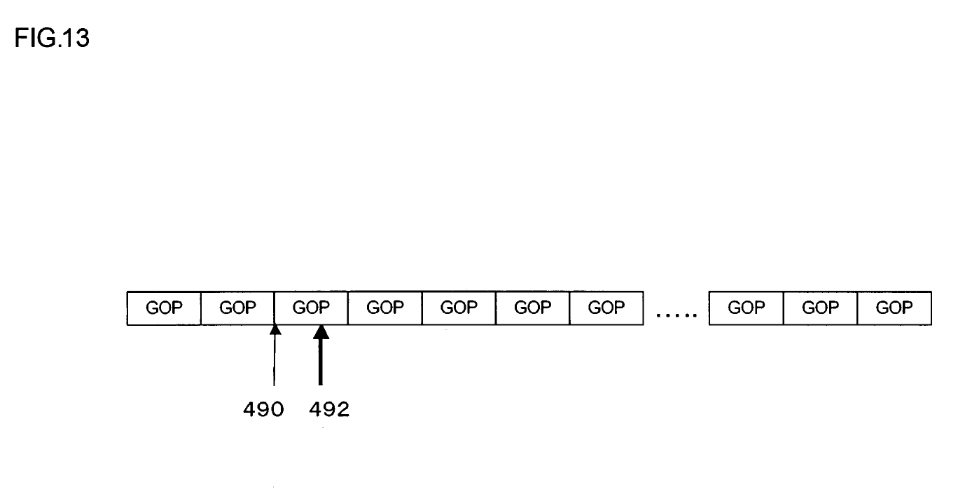

Further, as shown in FIG. 13, the MPEG video layer requires that decoding be started only at the head of a GOP. Thus, playback from a position in a file, in which an MPEG-TS is recorded, can only be designated with the precision defined by a GOP (generally speaking, 0.5 sec: 15 frames). Even when the video packet at the head of a GOP is designated as a start position, that GOP may not be played back because the video packets and audio packets that arrived before the PAT and the PMT are analyzed are discarded, so that playback may be started from the next GOP.

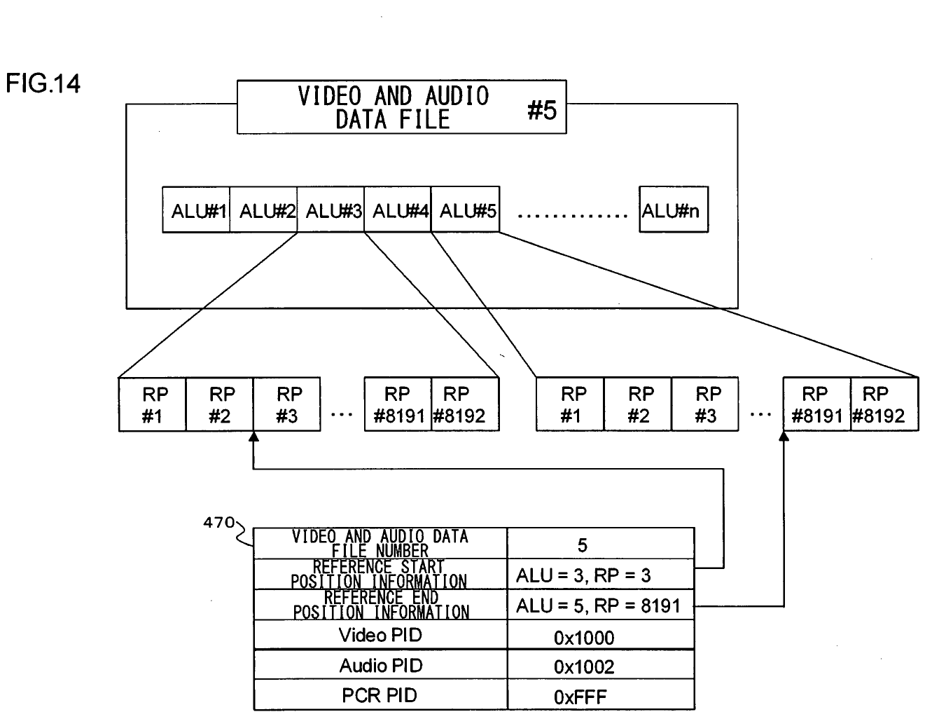

FIG. 14 shows the data structure of UPGRI and how a video and audio data file is referred to according to the embodiment. As shown in FIG. 14, UPGRI is expanded to incorporate fields for recording the PIDs of the transport packets in which the video data, audio data, and PCR data of the program referred to are stored. By introducing the fields, the user can designate the video packet at the head of a GOP, without having to be aware of the PAT and PMT information when designating a reference start position.

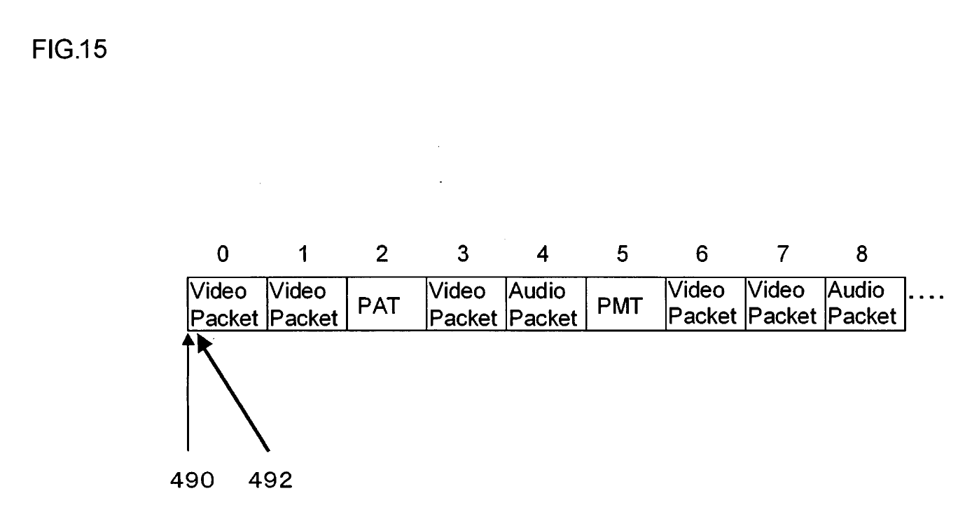

FIG. 15 shows how an MPEG-TS stream is analyzed when the PIDs of video, audio, and PCR are recorded. In this case, the MPEG-TS decoder 106 is capable of extracting a desired video packet, audio packet and PCR packet without analyzing the PAT and the PMT. Therefore, the reference start information and the position at which playback of a packet is started match. This prevents displacement of the playback start position to the position at the head of the first GOP that follows the designated position. Thereby, precision in designating the position is improved. Upon receipt of a packet identifier identifying a transport packet to be decoded, the MPEG-TS decoder 106 extracts and decodes a transport packet having the packet identifier received until the first PAT and the PMT of the transport stream have been analyzed. In the event of a failure to receive an identifier, the decoder 106 may extract a transport packet having the packet identifier obtained by analyzing the PAT and the PMT of the MPEG transport stream.

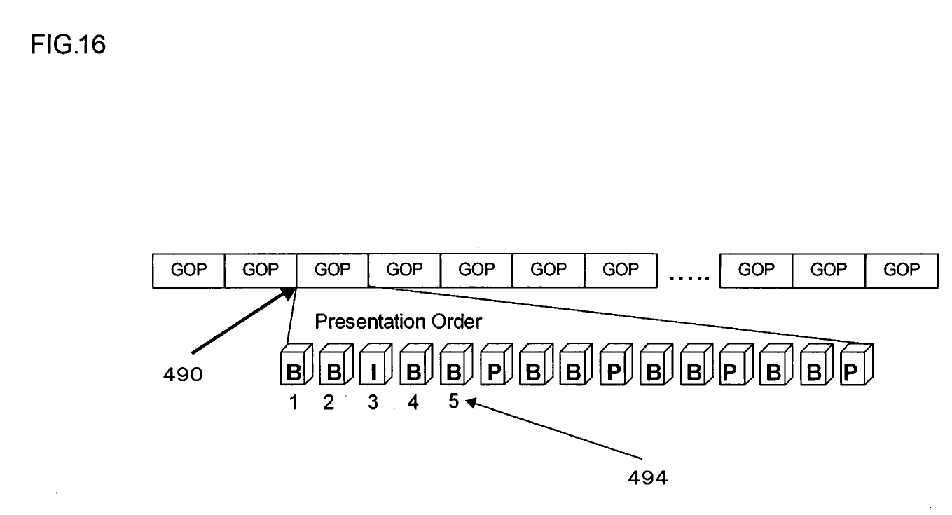

A description will now be given of expansion that enables frame-by-frame designation to address the related-art disadvantage that playback from a position in a file, in which an MPEG-TS is recorded, can only be designated with the precision defined by a GOP. FIG. 16 shows the structure of a sequence of frames in a GOP in the MPEG video layer in the presentation order. In the example of FIG. 16, the position 490 at the head of a GOP is designated, and the position 494 of a frame in the sequence is designated. When the user actually designate a desired frame in this GOP (in the illustrated example, the fifth frame), frame-by-frame designation is possible by recording the frame number (in this case, 5) with reference to the head or recording an offset time stamp since the start of display of the head frame.

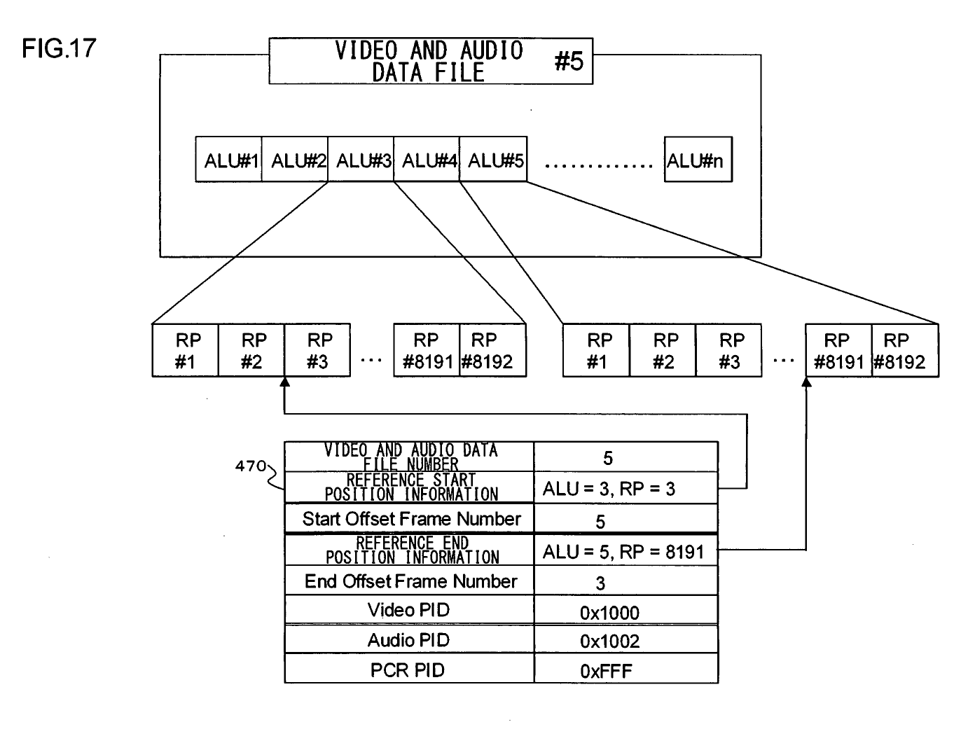

FIG. 17 shows the data structure of UPGRI and how a video and audio data file is referred to according to the embodiment. As shown in FIG. 17, in addition to the fields shown in FIG. 14, UPGRI incorporates a field for recording an offset frame number with reference to the head of a GOP at the reference start position, and a field for recording an offset frame number with reference to the head of a GOP at the reference end position. These fields may contain offset time stamp information instead of frame numbers. Thus, the inventive approach configures the data structure to indicate the position of a specific video frame in a program stored in the removable HDD unit 300 in which MPEG transport stream data is recorded. The data structure records a packet identifier identifying a transport packet storing a video elementary stream of a program to which the specific video stream belongs; information indicating the position in the removable HDD unit 300 at which the GOP to which the video frame belongs is recorded; and an offset frame number indicating the offset of the video frame from the head frame in the GOP to which the video frame belongs, or offset time stamp information with reference to the head frame. In this way, the user is capable of designating a block between desired frames in a video and audio data file.

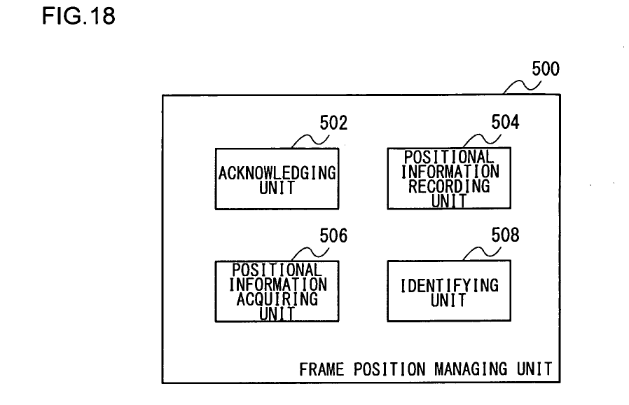

FIG. 18 shows the structure of the frame position managing unit 500. The frame position managing unit 500 is provided with an acknowledging unit 502, a positional information recording unit 504, a positional information acquiring unit 506, and an identifying unit 508. The configuration is implemented in hardware components such as a CPU of a computer, a memory, and in software such as a program loaded into the memory. FIG. 18 depicts functional blocks implemented by the cooperation of hardware and software. Therefore, it will be obvious to those skilled in the art that the functional blocks may be implemented in a variety of manners by hardware only, software only, and a combination thereof. The frame position managing unit 500 may be implemented as a function of the system controller 102.

The acknowledging unit 502 acknowledges a request for recording the positional information of a video frame in a program stored in the removable HDD unit 300 in which MPEG transport stream data is recorded. The acknowledging unit 502 may acknowledge a request for recording the positional information of a video frame occurring when playback is suspended. The acknowledging unit 502 may acknowledge a request for recording a playback start position, playback end position, bookmark position, or the positional information of a video frame representing a thumbnail image. In the above example, the acknowledging unit 502 acknowledges a request for recording a thumbnail and resume information in a PGRGI; a thumbnail, resume information, and index information in an OPGRI; and reference start position information, reference end position information, and index information in a UPGRI.

The positional information recording unit 504 records, as positional information of a video frame, information on the position in the removable HDD unit 300 at which a video frame is recorded; a packet identifier identifying a transport packet storing a video elementary stream of a program to which the video stream belongs; and an offset frame number indicating the offset of the video frame from the head frame in the GOP to which the video frame belongs, or offset time stamp information with reference to the head frame. In the above example, the video and audio data file number, ALU number, and RP number are recorded as information on the position in the removable HDD unit 300 at which a video frame is recorded. Also recorded are the PID of a transport packet storing data for a program to which the video, audio, and PCR packets belong; and an offset frame number with reference to the head frame of the video frame.

The positional information acquiring unit 506 acquires, as information indicating the position of a video frame in a program stored in the removable HDD unit 300 in which MPEG transport stream data is recorded, information indicating the position in the removable HDD unit 300 at which the video frame is recorded; a packet identifier identifying a transport packet storing a video elementary stream of a program to which the specific video stream belongs; and an offset frame number indicating the offset of the video frame from the head frame in the GOP to which the video frame belongs, or offset time stamp information with reference to the head frame.

The identifying unit 508 identifies the video frame by using the positional information acquired by the positional information acquiring unit 506. The identifying unit 508 uses the information on the recorded position acquired by the positional information acquiring unit 506 to read data, including the GOP to which the video frame belongs, from the removable HDD unit 300, and supplies the data to the MPEG-TS decoder 106. The MPEG-TS decoder 106 uses the packet identifier acquired by the positional information acquiring unit 506 to extract and decode the transport packet having the packet identifier from among the data supplied by the identifying unit 508. The identifying unit 508 uses the offset frame number or the offset time stamp information acquired by the positional information acquiring unit 506 to identify the video frame from among the video frames decoded by the MPEG-TS decoder 106.

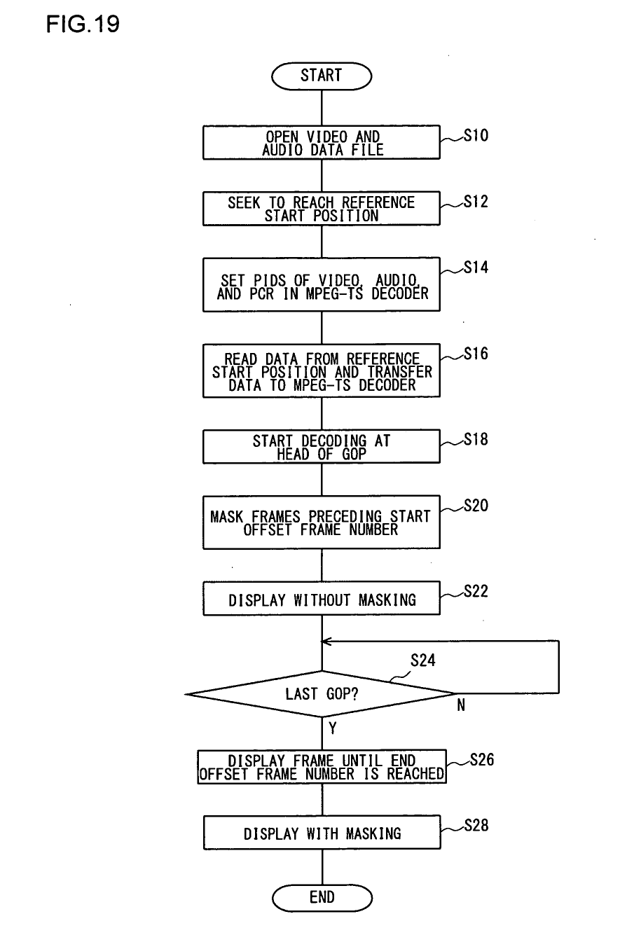

FIG. 19 is a flowchart showing the procedure for playback according to the embodiment. FIG. 19 shows steps for playing back between the reference start position and the reference end position stored in a UPGRI. When the positional information acquiring unit 506 acquires the UPGRI designated by the user from the UPGRI table 470 recorded in the removable HDD unit 300, the identifying unit 508 opens the video and audio data file 480 corresponding to the video and audio data file number recorded in the UPGRI (S10). The removable HDD unit 300 seeks for the RP in the ALU corresponding to the reference start position information recorded in the UPGRI (S12). The identifying unit 508 sets, in the MPEG-TS decoder 106, the PIDs, recorded in the UPGRI, of video, audio, and PCR (S14), and starts reading from the reference start position, so as to transfer the data thus read to the MPEG-TS decoder 106 (S16).

The MPEG-TS decoder 106 extracts a TS packet on the basis of the PIDs thus set, and starts decoding from the head of the GOP (S18). The identifying unit 508 masks the frames preceding a start offset frame number recorded in the UPGRI to prevent them from being displayed (S20), and displays the video frame identified by the start offset frame number and subsequent frames (S22) without applying any masks. Thus, the display device 110 starts displaying the video frame designated to be displayed and subsequent frames.

The identifying unit 508 continues to read RPs from the removable HDD unit 300 and to supply the RPs to the MPEG-TS decoder 105 until the RP at the reference end position recorded in the UPGRI is reached (N in S24). When the last GOP is reached (Y in S24), the specifying unit 508 allows the display device 110 to display frames until an end offset frame number recorded in the UPGRI is reached (S26), and masks the subsequent frames to prevent them from being displayed (S28). In this way, the display device 110 terminates the display at the video frame designated to be displayed last.

In this embodiment, the end offset frame number field is added to the reference end position information so as to allow designating the last displayed frame number in the GOP immediately preceding the reference end position. Alternatively, the frame number in the GOP immediately following the reference end position may be designated. In this case, playback may be conducted by interpreting the frame number to mean that the frame immediately following the reference end position is designated. What is essential is that recording and playback are performed under the same understanding. The reference end position may be designated by providing for information on a period referred to (reference period information). In this case, the position may be represented by the number of frames referred to or a time stamp referred to.

The scheme in which a video PID and a start offset frame number are added to the reference start position information can be used to designate a resume frame, to designate a thumbnail frame, or to designate an index position, as well as for the purpose of virtual editing.

These embodiment is intended to be illustrative only and it will be obvious to those skilled in the art that various modifications to constituting elements and processes could be developed and that such modifications are also within the scope of the present invention.

What is claimed is:

1. A recording apparatus comprising:
an acknowledging unit which acknowledges a request for recording positional information of a video frame in a program stored in a recording medium in which MPEG transport stream data is recorded; and
a positional information recording unit which records, as positional information of the video frame, information on the position in the recording medium at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame.

2. The recording apparatus according to claim 1, further comprising:
a data recording unit which acquires the MPEG transport stream data and records the same in the recording medium.

3. The recording apparatus according to claim 1, further comprising:
a playback unit which reads data for the program from the recording medium and plays back the data, wherein the acknowledging unit acknowledges a request for recording positional information of a video frame occurring when playback by the playback unit is suspended.

4. The recording apparatus according to claim 1, further comprising:
a playback unit which reads data for the program from the recording medium and plays back the data, wherein
the acknowledging unit acknowledges a request from a user for recording a playback start position, playback end position, bookmark position, or positional information of a video frame representing a thumbnail image.

5. A recording method comprising:
acknowledging a request for recording positional information of a video frame in a program stored in a recording medium in which MPEG transport stream data is recorded; and
recording, as positional information of the video frame, information on the position in the recording medium at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame.

6. A playback apparatus comprising:
a decoder unit which extracts and decodes a transport packet, storing a video elementary stream of a program, from MPEG transport stream data;
a positional information acquiring unit which acquires, as positional information of a video frame in a program stored in a recording medium in which the MPEG transport stream data is recorded, information on the position in the recording medium at which the video frame is recorded; a packet identifier identifying a transport packet storing a video elementary stream of a program to which the video frame belongs; and an offset frame number indicating the offset of the video frame from the head frame in a GOP to which the video frame belongs, or offset time stamp information with reference to the head frame; and
an identifying unit which identifies the video frame by using the positional information, wherein
the identifying unit uses the information on the recorded position acquired by the positional information acquiring unit to read data, including the GOP to which the video frame belongs, from the recording medium, and supplies the data to the decoding unit,
the decoder uses the packet identifier acquired by the positional information acquiring unit to extract and decode the transport packet having the packet identifier from among the data supplied by the identifying unit, and
the identifying unit uses the offset frame number or the offset time stamp information acquired by the positional information acquiring unit to identify the video frame from among the video frames decoded by the decoding unit.

7. The playback apparatus according to claim 6, wherein upon receipt of a packet identifier identifying a transport packet to be decoded, the decoder extracts and decodes the transport packet having the packet identifier, and in the event of a failure to receive an identifier, the decoder extracts and decodes a transport packet having a packet identifier obtained by analyzing program identifying information included in the MPEG transport stream.

8. The playback apparatus according to claim 6, further comprising:
a display unit which displays the video frame decoded by the decoding unit, wherein
the positional information acquiring unit acquires positional information of a video frame at which display is to be started or ended,
the display unit starts displaying the video frame identified by the identifying unit and subsequent frames, or terminates the display at the video frame identified by the identifying unit.

9. The playback apparatus according to claim 7, further comprising:
a display unit which displays the video frame decoded by the decoding unit, wherein
the positional information acquiring unit acquires positional information of a video frame at which display is to be started or ended,
the display unit starts displaying the video frame identified by the identifying unit and subsequent frames, or terminates the display at the video frame identified by the identifying unit.

10. A data structure indicating a position of a video frame in a program stored in a recording medium in which MPEG transport stream data is recorded, comprising:
a packet identifier identifying a transport packet storing a video elementary stream of a program to which the video frame belongs;
information indicating the position in the recording medium at which a GOP to which the video frame belongs is recorded;
an offset frame number indicating the offset of the video frame from the head frame in a GOP to which the video frame belongs, or offset time stamp information with reference to the head frame.
